(19) United States
(12) Patent Application Publication
(10) Pub. No.: US 2012/0093175 A1
(43) Pub. Date: Apr. 19, 2012

(54) METHOD AND APPARATUS OF TRANSMITTING PACKET IN COMMUNICATION SYSTEM

(75) Inventors: Sung Jin YOU, Daejeon-si (KR); Gwang Zeen KO, Daejeon-si (KR); Jin Suk PAK, Daegu-si (KR); Byung Jang JEONG, Daejeon-si (KR); Sang Won KIM, Daejeon-si (KR)

(73) Assignee: Electronics and Telecommunications Research Institute, Daejeon (KR)

(21) Appl. No.: 13/275,999

(22) Filed: Oct. 18, 2011

(30) Foreign Application Priority Data
Oct. 19, 2010 (KR) 10-2010-0102149
Mar. 28, 2011 (KR) 10-2011-0027393

(51) Int. Cl. H04J 3/22

(52) U.S. Cl. 370/465

(57) ABSTRACT

A method and an apparatus for transmitting a packet in a communication system are provided. The method for transmitting a packet in a communication system includes receiving a compression packet use request message from a receiver; generating a specific preamble and transmitting the compression packet to a receiver; wherein the compression packet is generated by omitting information on overlapping frame header among a frame to be transmitted and attaching the specific preamble including the information on the omitted frame header.

### CROSS-REFERENCE TO RELATED APPLICATIONS

This application claims the benefit of priority of Korean Patent Application No. 10-2010-0102149 filed on Oct. 19, 2010, and Korean Patent Application No. 10-2011-0027393 filed on Mar. 28, 2011, all of which are incorporated by reference in their entirety herein.

### BACKGROUND OF THE INVENTION

1. Field of the Invention

The present invention relates to packet transmission in a communication system, and more particularly, to a method for transmitting a packet using header compression and an apparatus for supporting the same.

2. Related Art

Increasing data transmission efficiency so as to meet a request of a user in a wired and wireless communication system is considered as an important technology for a long period of time. In particular, an importance for a technology of efficiently using frequency resources due to a sudden increase in a radio data demand has been further interested.

Types of packets in a general communication system may be largely divided into a user data packet and a control packet. The user data packet is generated in user application and means a packet to be used by an actual communication system. The control packet means a packet that controls operations of a communication device such as error correction, flow control, or the like, so as to smoothly transmit the user data packet. The communication user data transmission efficiency is affected according to how efficiently the packets are transmitted.

A packet associated with ARQ among the control packets is a packet to be continuously transmitted when transmitting user data. In this case, the efficiency transmission of the packet has a significant effect on the user data transmission efficiency.

In the related art, in order to reduce overhead due to the packet, Go-back-N ARQ, Selective-repeat ARQ, or Adaptive ARQ, or the like, have been widely used so as to reduce a transmission number in times of the control packet.

### SUMMARY OF THE INVENTION

The present invention provides a method and an apparatus for transmitting a packet in a communication system. The present invention also provides a method for mapping header information in header compression using preambles.

In an aspect, there is provided a method for transmitting a packet in a communication system, including: receiving a compression packet use request message from a receiver; and generating a specific preamble and transmitting the compression packet to the receiver; wherein the compression packet is generated by omitting information on an overlapping frame header among a frame to be transmitted and attaching the specific preamble including the information on the omitted frame header.

The receiving of the request message may further include transmitting a compression packet use approval message to the receiver as a response to the compression packet use request message.

The transmission of the compression packet may be performed as the response to the compression packet request message of the receiver.

The specific preamble may be obtained based on a bit stream of the preamble and a device ID of the transmitter.

The specific preamble may be obtained based on the bit stream of the preamble and a connection ID of the transmitter.

The specific preamble may be obtained based on the bit stream of the preamble and the compressed header information.

In another aspect, there is provided a method for transmitting a packet in a communication system, including: transmitting a specific preamble use request message to a receiver; and generating a specific preamble and transmitting the compression packet to the receiver, wherein the compression packet is generated by omitting information on overlapping frame header among a frame to be transmitted and attaching the specific preamble including the information on the omitted frame header.

In another aspect, there is provided a method for transmitting a packet in a communication system, including: transmitting a specific preamble use request message to a manager; receiving a specific preamble use approval message as a response to the specific preamble use request message from the manager; and generating the specific preamble and transmitting a compression packet to a receiver, wherein the compression packet is generated by omitting information on overlapping frame header among a frame to be transmitted and attaching the specific preamble including the information on the omitted frame header.

The receiver may receive the specific preamble use approval message transmitted by the manager.

In another aspect, there is provided an apparatus for transmitting a packet in a communication system, including: a transceiver set to transmit and receive a compression packet; and a process functionally connected to the transceiver, wherein the processor receives a compression packet request message from a receiver, and generates a specific preamble and sets to transmit the compression packet to the receiver, and wherein the compression packet is generated by omitting information on overlapping frame header among a frame to be transmitted and attaching the specific preamble including the information on the omitted frame header.

### BRIEF DESCRIPTION OF THE DRAWINGS

FIG. 1 is a diagram showing an example of a frame structure that may be applied to a communication system.

FIG. 2 is a diagram showing a packet transmission method according to an exemplary embodiment of the present invention.

FIG. 3 is a diagram showing a packet transmission method according to another exemplary embodiment of the present invention.

FIG. 4 is a diagram showing a packet transmission method according to another exemplary embodiment of the present invention.

FIG. 5 is a block diagram showing an example of a compression packet according to the exemplary embodiment of the present invention.

FIG. 6 is a diagram showing examples of a method for generating specific preambles.

FIG. 7 is a diagram showing a detailed example of generating the specific preambles by mapping information to preambles.

FIG. 8 is a block diagram showing an ACK packet of IEEE 802.11.

FIG. 9 is a diagram showing the packet shown in FIG. 8 compressed using the specific preambles according to the exemplary embodiment of the present invention.

FIG. 10 is a block diagram showing a packet transmission apparatus implemented according to the exemplary embodiment of the present invention.

### DESCRIPTION OF EXEMPLARY EMBODIMENTS

A packet transmission method proposed according to exemplary embodiments of the present invention allows preambles of each packet to achieve synchronization purpose and differentiate a kind of packets like the existing methods in transmitting control messages, thereby replacing control messages only through the detection of the preambles. In this case, the exemplary embodiments of the present invention change each message or header information into the specific preambles, which are in turn transmitted. In this case, each message or the header information needs to be mapped using the preambles.

In describing below the exemplary embodiments of the present invention, the preambles according to the exemplary embodiments of the present invention obtained by mapping each message or the header information using the preamble are referred to as specific preambles. The specific preamble means a preamble that may be dynamically allocated. That is, the specific preamble means a preamble that may be allocated and recovered according to a kind of devices or a kind of streams, if necessary. The specific preamble may be selected from at least two preamble sets and may be determined in a random manner.

Hereinafter, the exemplary embodiments of the present invention will be described in more detail with reference to the accompanying drawings.

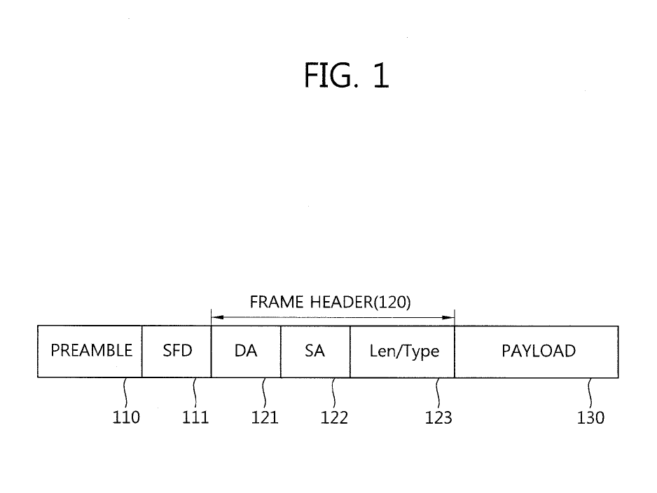

FIG. 1 is a diagram showing an example of a frame structure that may be applied to a communication system.

The frame structure in a general frame based network is configured to include a preamble 110, a frame header 120, and a payload 130.

The preamble 110 means a region attached to the head of a header of each frame for frame synchronization in a frame unit. In the case of Ethernet, a main object of the preamble is to implement bit synchronization so as to match a transmitting and receiving speed by continuing 56 bits or more including 1 and 0 repeated like 101010. In the case of wireless mobile communication, the preamble is used for timing estimation, or the like, for an initial symbol using a continuously transmitted signal.

A start of frame delimiter (SFD) 111 means a bit stream in 1 byte unit configured by 10101011 that is attached to just after the preamble from a start of an Ethernet frame. Bit streams after the SFD bit stream are a bit stream for frame synchronization informing that they are configured in 1 byte unit.

A frame header 120 includes a destination address (DA) 121, a source address (SA) 122, and a Len/Type 123.

In the Len/Type 123, Length means a maximum size that may be carried by a single frame and Type indicates to which protocol the capsulated data correspond.

A variety of wired/wireless communication systems use a frame structure similar to the frame structure shown in FIG. 1 to transmit/receive control data and user data. The exemplary embodiments of the present invention may be applied to the wired/wireless communication system that transmits and receives data using the frame structure. Hereinafter, the frame represented by the detailed exemplary embodiments of the present invention may be modified so as to meet the actually applied communication system. That is, a sequence of each field configuring a name and a frame, or the like, may be controlled according to the existing frame structure used in each communication system while being specifically applied to each communication system and necessary control information, or the like, may be further provided.

Hereinafter, a compression packet is a packet that replaces the preambles in the frame structure according to the related art with specific preambles according to the exemplary embodiment of the present invention. When the specific preamble according to the exemplary embodiments of the present invention is applied, the contents of the repeated header may be omitted. For example, in the case of the video stream, the frame head may include a source address, a destination address, a header type, or the like. When all the information of the frame header overlaps for a predetermined time, all the frame header information may be omitted. However, when portions of the frame header information overlap, only the overlapping portions are omitted, thereby increasing transmission efficiency in communication.

When no repeated contents are among the frame header information or the repeated time is short, the general purpose preambles are allocated, thereby performing the communication like a general frame based communication method. The general purpose preambles may be dynamically allocated in a similar manner to the specific preambles and may be fixedly allocated to a defined value.

When the overlapping frame header information is omitted, a length of the frame data is relatively shorter than a length of the general frame data. When all the information among the frame header information overlaps, the frame header information may be omitted.

The method for transmitting a compression packet using the specific preambles according to the exemplary embodiment of the present invention may be used as a method for allocating the specific preambles for each video stream in the data transmission in which the header contents are not changed for a predetermined time like video streaming services.

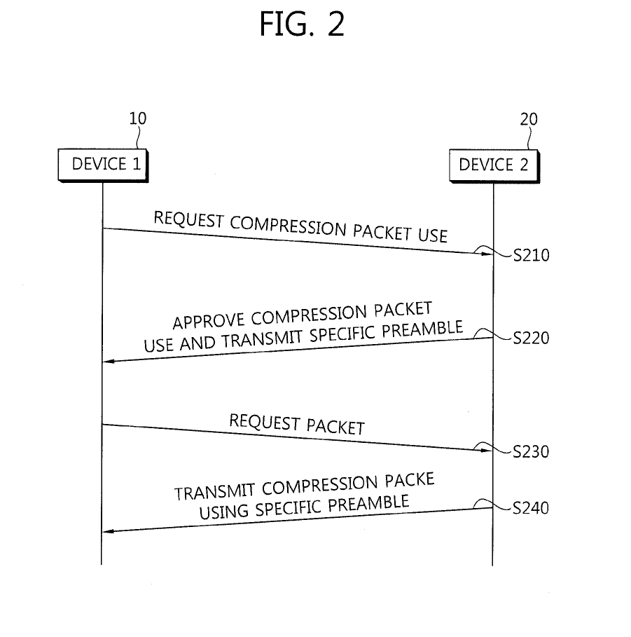

As an example of generating the specific preambles, a transmitter may extract the contents of the repeated frame header and may generate the specific preambles mapped to the omitted frame header information at an initialization step of the communication system. The transmitter transmits the omitted frame header information and the preamble to the receiver to share the information on the specific preambles. The detailed procedure informing the generation and application of the specific preambles will be described below in more detail with reference to FIGS. 2 to 4.

FIG. 2 is a diagram showing a packet transmission method according to an exemplary embodiment of the present invention.

In the following example, device 1 10 and device 2 20 are a communication device that transmits and receives packets and may be referred to as various names such as a terminal, a subscriber equipment, a station, a mobile terminal, or the like. The device 2 20 is a transmitter or a source station that transmits the packets and the device 1 10 is a receiver or a destination station that receives the packets. A transmitting/receiving concept of the device 1 10 and the device 2 20 is relative to each other and therefore, a role of the transmitter and the receiver may be replaced with each other according to a flow of data.

The device 1 20 that is a message receiver requests the compression packet use before the device 2 20 transmits the messages.

The device 2 20 receiving the compression packet use request from the device 1 10, which is a response to the compression packet use request, transmits the specific preambles to be used in the compression packet together with the message for the compression packet use approval when the device 2 20 permits the device compression packet use (S220). In this case, the use approval and the specific preambles may be transmitted as a single packet as in the example of FIG. 2 or as a separate packet according to the exemplary embodiment of the present invention. When the device 1 10 receiving the specific preambles complete a preparation for detecting the specific preambles, the device 1 10 informs (packet request) the state to the device 2 20 (S230) so that the device 2 20 may use the specific preambles to transmit the compressed packet (S240). In this case, a process of allowing the device 1 10 to request the packets to the device 2 20 may be omitted. According to the exemplary embodiment of the present invention, the device 1 10 requesting the compression packet use without performing the process of requesting the packets of the device 1 10 (S230) approves the compression packet use and when the specific preambles are received from the device 2 20, the device 2 20 may transmit the compression packet using the specific preamble without requesting the packet transmission.

An example of FIG. 2 is an example of a process of mapping the compressed information with the specific preambles by allowing the receiver (device 1) to request the compressed packet use but the compressed packet use request may be performed by a message transmitter.

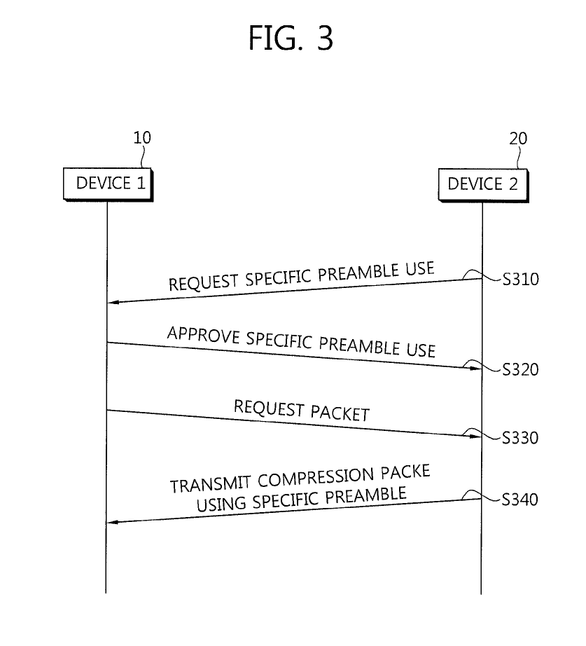

FIG. 3 is a diagram showing a packet transmission method according to another exemplary embodiment of the present invention.

Unlike the example of FIG. 2, FIG. 3 is an example of mapping the compressed information with the specific preambles by allowing the message transmitter to request the compressed packet use. The device 2 20 that is the message transmitter requests the use of the specific preamble to the device 1 10 that is the message receiver prior to transmitting the messages (S310). The specific preamble use request message may be used to inform the device 1 10 that the device 2 20 informs the device 1 10 that the compression packet is transmitted using the specific preambles later or confirm whether the device 1 10 has capability receiving the compression packet using the specific preamble.

According to the exemplary embodiments of the present invention, when the device 2 20 is informed that the device 1 10 has the capability receiving the compression packet using the specific preamble, the device 2 20 informs that the compression packet using the specific preamble may be transmitted to the specific preamble use request message later and may transmit the compression packet using the specific preamble without the procedure (S320) of receiving the specific preamble use approval message. In this case, in an example of FIGS. 3, S320 and S330 may be omitted.

As the response to the specific preamble use request message, the device 1 10 approves it (S320) and then, prepares to detect the specific preamble to be transmitted later. Thereafter, when the packet request (S330) is performed, the device 2 20 transmits the compression packet to the device 1 10 using the specific preamble (S340). In this case, a process of allowing the device 1 10 to request the packets to the device 2 20 may be omitted as described in the exemplary embodiment of FIG. 2.

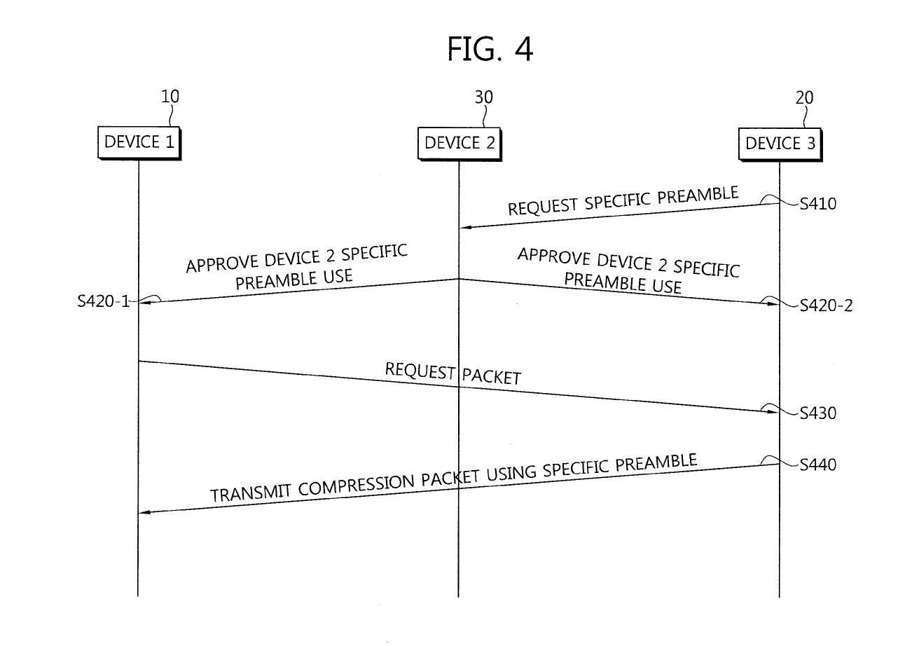

FIG. 4 is a diagram showing a packet transmission method according to another exemplary embodiment of the present invention.

An example of FIG. 4 is an example in which a third device, neither the transmitter nor the receiver of the message, maps the compressed information with the specific preamble. That is, a method for mapping the specific preambles using the third device that does not transmit or receive the compression packet is shown. The third device may be referred to as a manager that is not directly associated with the transmission or reception of the compression packet between the transmitter and the receiver of the compression packet. As an example, in the IEEE 802.11 system, when the transmitter and the receiver sets a direct link to transmit and receive the data frame through the direct link, the third device may be a device performing a function such as an access point (AP) that is in connection with only the direct link setup procedure and is not in connection with the frame transmission/reception through the direct link after the setting of the direct link. When the example described below is applied to the IEEE 802.11 system, the following device 1 and device 2 are a station performing the direct link setup (DLS) procedure, the device 3 may be replaced with the AP, and the specific preamble use request and the use approval procedure may be made as described in the DLS setup procedure.

The device 2 20 informs a device 3 30 that the device 2 20 intends to transmit the compressed packet to the device 1 10 using the specific preamble (S410). In this case, the device 3 30 informs the device 1 10 and the device 2 20 that the device 2 20 intends to transmit data using the specific preamble (S420-1 and S420-2). In this case, the device 1 10 prepares to detect the specific preambles. When the device 1 10 completes a preparation for detecting the specific preambles, the device 1 10 informs the state to the device 2 20 (packet request) (S430). Therefore, the device 2 20 transmits the compression packet using the specific preamble (S440). In this case, the device 2 20 may transmit the compression packet using the specific preamble after the specific time (e.g. an inter-specific frame interval, an expiration of a period set in a timer) lapses by using a timer, or the like, without the device 1 10 transmitting the packet request message to the device 2 20.

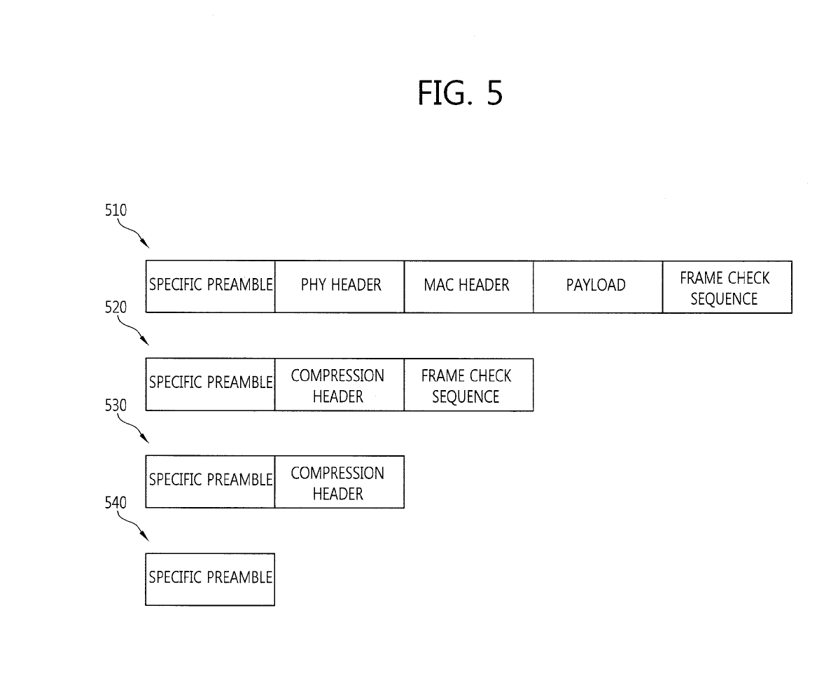

FIG. 5 is a block diagram showing an example of a compression packet according to the exemplary embodiment of the present invention.

In FIG. 5, a frame 510 is an example of a general transmission packet. FIG. 5 shows that a frame 520, a frame 530, and a frame 540 are a packet when a general transmission packet 510 is compressed through a specific preamble.

Among the control messages, there may be a packet without a payload in the general transmission packet 510. In this case, the frame 520, the frame 530, and the frame 540 show a shape in which the packets are compressed through the specific preamble. The specific preamble may be randomly generated and may be generated with the fundamental information on the device and the traffic.

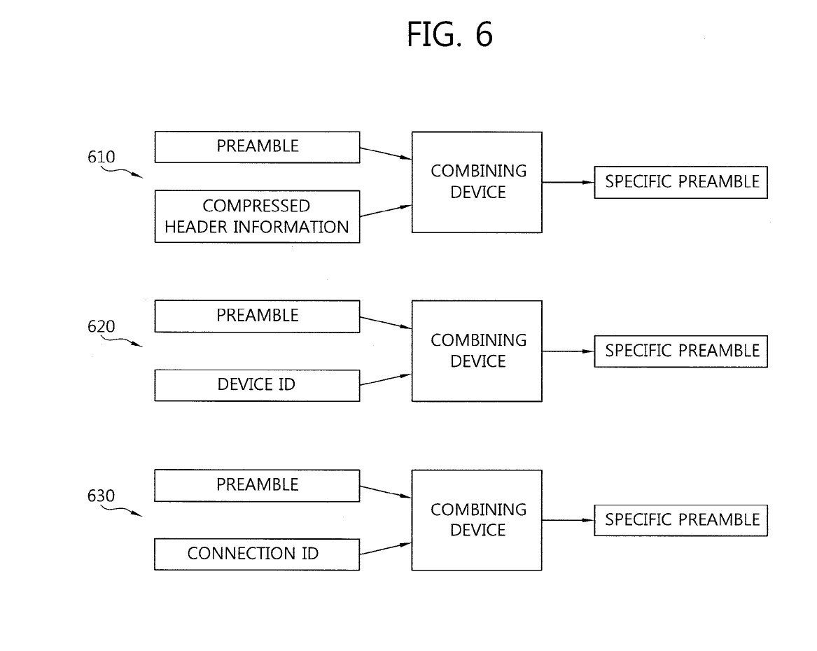

FIG. 6 is a diagram showing examples of a method for generating specific preambles.

The specific preamble may be generated by combining compressed header information, device ID, and connection ID. Each of the devices 610, 620, and 630 for generating the specific preambles of FIG. 5 shows an example of generating the specific preambles by combining an original preamble with the compressed header information, the device ID, or the connection ID.

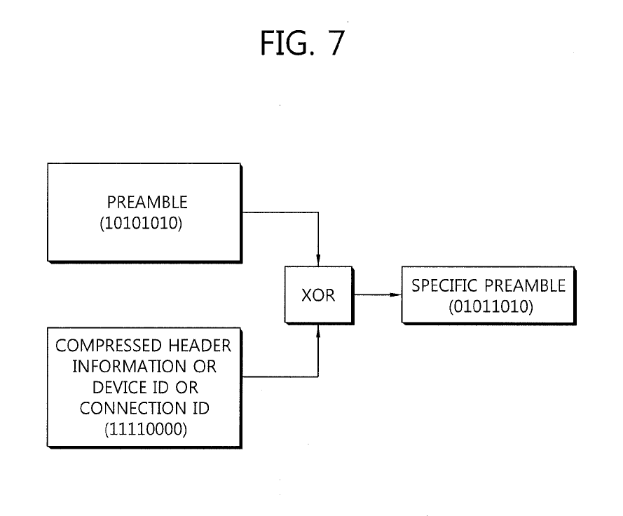

FIG. 7 is a diagram showing a detailed example of generating the specific preambles by mapping information to the preambles.

FIG. 7 shows an example of generating the specific preambles by mapping the compressed header information, the device ID, or the connection ID shown in FIG. 6 to the preambles. In the example of FIG. 7, the case of performing exclusive (XOR) operation by a mapping method is shown.

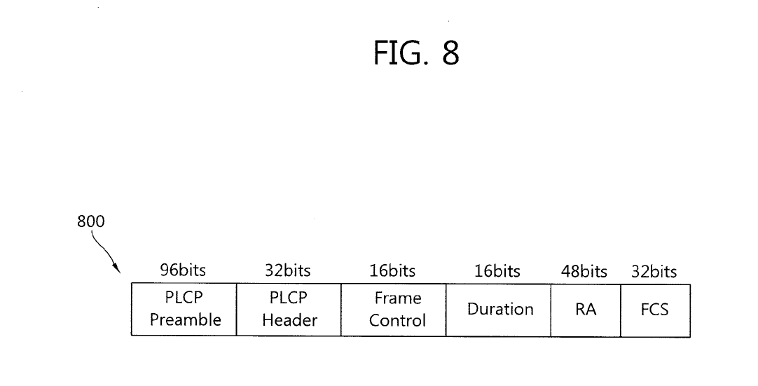

FIG. 8 is a block diagram showing an ACK packet of IEEE 802.11.

The ACK packet of FIG. 8 briefly shows PPDU including the ACK frame transmitted as receiving acknowledge response from the station receiving the data frame to a transmission station in the wireless LAN system.

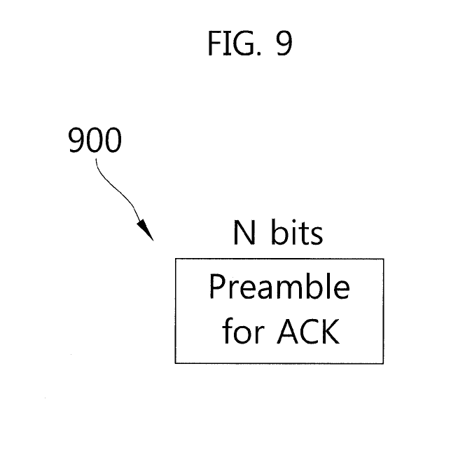

FIG. 9 is a diagram showing the packet shown in FIG. 8 compressed using the specific preambles according to the exemplary embodiment of the present invention.

FIG. 9 shows the ACK message generated by compressing the packet shown in FIG. 8 using the exemplary embodiment of the present invention. In this case, the compression effect may be varied according to the length of the specific preambles. That is, when using the preamble of 96 bits similar to one used in FIG. 8, it can be appreciated that a length of the packet is reduced to about ⅖ of the original size.

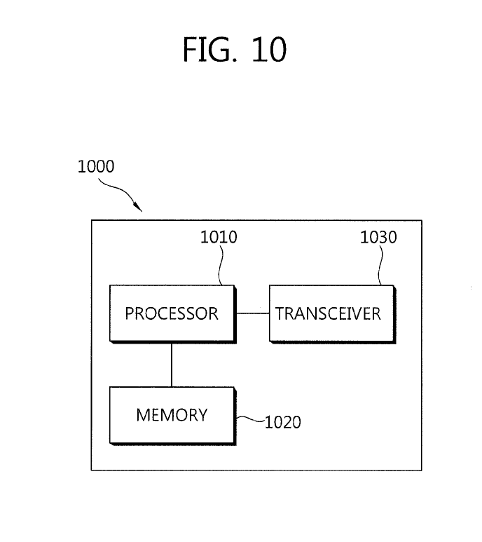

FIG. 10 is a block diagram showing a packet transmission apparatus implemented according to the exemplary embodiment of the present invention. An apparatus 1000 may be functioned as the transmitter or the receiver in the exemplary embodiments of the present invention as described above.

The packet transmission apparatus 1000 includes a processor 1010, a memory 1020, and a transceiver 1030. The transceiver 1030 may have a plurality of network interface card (NICs). The processor 1010 is functionally connected to the transceiver 1030 to generate the specific preambles and generate the compression packet, and process the received compression packet, according to the method proposed according to the exemplary embodiments of the present invention. The processor 1010 and/or the transceiver 1030 may include an application-specific integrated circuit (ASIC), other chip sets, a logical circuit and/or a data processing device. The memory 1020 may include a read-only memory (ROM), a random access memory (RAM), a flash memory, a memory card, a storage medium and/or other storage devices. When the exemplary embodiments of the present invention are implemented by software, the above-mentioned methods may be implemented by a module (process, function, or the like) performing the above-mentioned functions. The module is stored in the memory 1020 and may be executed by the processor 1010. The memory 1020 may be mounted in or out the processor 1010 and may be connected to the processor 1010 by well-known various units. The apparatus 1000 may be operated as the terminal of the wired/wireless communication according to a wireless communication protocol and the setting implemented in the processor 1010.

As set forth above, the exemplary embodiments of the present invention can transmit a larger amount of user data packet corresponding to the reduced size and reduce the transmission error probability of the packet, by reducing the size of the packet to be transmitted in the communication system. In addition, the exemplary embodiments of the present invention can reduce the inter-frame space by reducing the time consumed to process the control messages. Further, the exemplary embodiments of the present invention can improve the communication system transmission efficiency by reducing the protocol overhead due to the packet loss.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belonging to the following claims.

What is claimed is:

1. A method for transmitting a packet in a communication system, comprising:
receiving a compression packet use request message from a receiver; and
generating a specific preamble and transmitting the compression packet to the receiver;
wherein the compression packet is generated by omitting information on overlapping frame header among a frame to be transmitted and attaching the specific preamble including the information on the omitted frame header.

2. The method of claim 1, wherein the receiving of the request message further includes transmitting a compression packet use approval message to the receiver as a response to the compression packet use request message.

3. The method of claim 1, wherein the transmission of the compression packet is performed as the response to the compression packet request message of the receiver.

4. The method of claim 1, wherein the specific preamble is obtained based on a bit stream of the preamble and a device ID of the transmitter.

5. The method of claim 1, wherein the specific preamble is obtained based on the bit stream of the preamble and a connection ID of the transmitter.

6. The method of claim 1, wherein the specific preamble is obtained based on the bit stream of the preamble and the compressed header information.

7. A method for transmitting a packet in a communication system, comprising:
transmitting a specific preamble use request message to a receiver; and
generating a specific preamble and transmitting the compression packet to the receiver,
wherein the compression packet is generated by omitting information on overlapping frame header among a frame to be transmitted and attaching the specific preamble including the information on the omitted frame header.

8. The method of claim 7, wherein the transmitting of the request message further includes receiving, from a receiver, a specific preamble use approval message as a response to the specific preamble use request message.

9. The method of claim 7, wherein the transmission of the compression packet is performed as the response to the compression packet request message of the receiver.

10. The method of claim 7, wherein the specific preamble is obtained based on a bit stream of the preamble and a device ID of the transmitter.

11. The method of claim 7, wherein the specific preamble is obtained based on the bit stream of the preamble and a connection ID of the transmitter.

12. The method of claim 7, wherein the specific preamble is obtained based on the bit stream of the preamble and the compressed header information.

13. A method for transmitting a packet in a communication system, comprising:
transmitting a specific preamble use request message to a manager;
receiving, from the manager, a specific preamble use approval message as a response to the specific preamble use request message; and
generating the specific preamble and transmitting a compression packet to a receiver,
wherein the compression packet is generated by omitting information on overlapping frame header among a frame to be transmitted and attaching the specific preamble including the information on the omitted frame header.

14. The method of claim 13, wherein the receiver receives the specific preamble use approval message transmitted by the manager.

15. An apparatus for transmitting a packet in a communication system, comprising:
a transceiver set to transmit and receive a compression packet; and
a process functionally connected to the transceiver,
wherein the processor receives a compression packet request message from a receiver, and
generates a specific preamble and sets to transmit the compression packet to the receiver, and
wherein the compression packet is generated by omitting information on overlapping frame header among a frame to be transmitted and attaching the specific preamble including the information on the omitted frame header.
